(19) United States
(12) Patent Application Publication
(10) Pub. No.: US 2021/0383469 A1
(43) Pub. Date: Dec. 9, 2021

(54) CURRENCY TRADING METHOD BASED ON BLOCKCHAIN AND ELECTRONIC DEVICE

(71) Applicant: HON HAI PRECISION INDUSTRY CO., LTD., New Taipei (TW)

(72) Inventors: CHIA-HUNG CHOU, New Taipei (TW); SHIAW-HERNG LIU, New Taipei (TW)

(21) Appl. No.: 17/342,839

(22) Filed: Jun. 9, 2021

(30) Foreign Application Priority Data
Jun. 9, 2020 (CN) 202010518893.4

(51) Int. Cl. G06Q 40/04; G06Q 20/38

(52) U.S. Cl. CPC G06Q 40/04; G06Q 20/389

(57) ABSTRACT

A currency trading method based on blockchain applied in an electronic device sets up a smart contract on the blockchain to receive a first setting instruction and a quantity of first transactions from a transacting sender, and receives a second setting instruction and a quantity of second transactions from a transacting receiver. The smart contract further generates target transactions according to a first exchange rate, the quantity of the first transactions, and a second exchange rate and the quantity of the second transactions, and sends the target transactions to a third-party platform for mediation of the target transactions. In response to a redemption instruction sent by the third-party platform, the smart contract sends the second tokens corresponding to the quantity of the first transactions to the transacting sender to a transacting receiver according to the quantity of the second transactions and the second exchange rate.

### CROSS-REFERENCE TO RELATED APPLICATIONS

This application claims priority to Chinese Patent Application No. 202010518893.4 filed on Jun. 9, 2020, the contents of which are incorporated by reference herein.

### FIELD

The subject matter herein generally relates to blockchain, especially to a currency trading method based on blockchain and an electronic device using the same.

### BACKGROUND

Free currency trading is one of the cornerstones of modern commercial society. The common basis of asset trading and currency circulation is trust in value, by both transaction parties, and trust in trading rules. However, current trading methods, in order to build a trust between unfamiliar parties, or as to reliability of assets, the cost is considerable, and establishment of a variety of large central organizations, as well as various government regulatory bodies are needed to achieve free and convenient asset transactions. The current trading method requires manual operations which mistakes may happen because of the complexity of the currency transaction processes.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a currency trading method based on blockchain according to the present disclosure.

FIG. 2 is a block diagram of an embodiment of a currency trading system based on blockchain according to the present disclosure.

FIG. 3 is a block diagram of an embodiment of an electronic device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

The disclosed currency trading method based on blockchain can be applied in one or more electronic devices. The electronic device is a device with pre-set or stored instructions. Hardware of the electronic device includes, but is not limited to, a microprocessor, an Application Integrated Circuit (ASIC), a Programm-Field Gate Array (FPGA), a Digital Signal Processor (DSP), an embedded devices, etc.

The electronic device may be a computing device such as a desktop computer, a laptop computer, a tablet computer and a cloud server. The electronic device may interact with users by a keyboard, a mouse, a remote control, a touchpad or a voice-activated device.

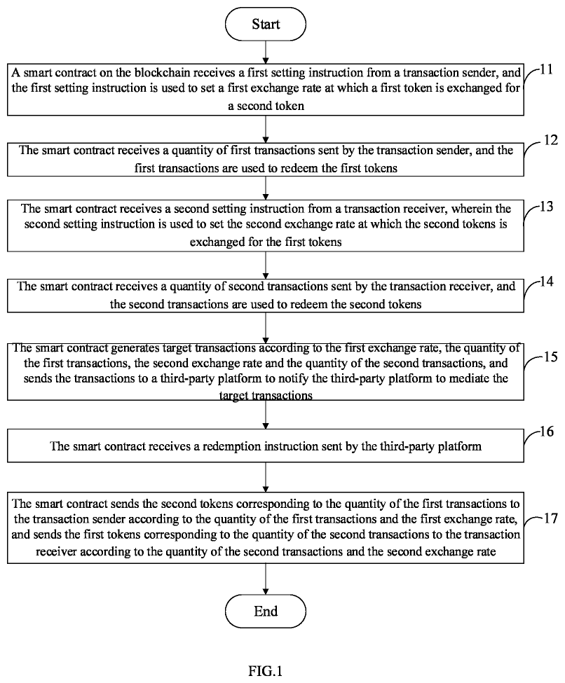

FIG. 1 illustrates a flowchart of the currency trading method based on blockchain. The method is provided by way of example, as there are a variety of ways to carry out the method. Each block shown in FIG. 1 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 11.

At block 11, a smart contract on the blockchain receives a first setting instruction from a transaction sender, and the first setting instruction is used to set a first exchange rate at which a first token is exchanged for a second token.

In one embodiment, the blockchain includes multiple blockchain nodes, each blockchain node includes the smart contract. The transaction sender is connected to one blockchain node on the blockchain. In one embodiment, the smart contract on the blockchain receives the first setting instruction sent by the smart contract on the blockchain node corresponding to the transaction sender. In one embodiment, the transaction sender is a terminal device, and for example, the terminal device may be a laptop, a smartphone, a tablet and other devices, or the transaction sender may be an account address.

At block 12, the smart contract receives a quantity of first transactions sent by the transaction sender, and the first transactions are used to redeem the first tokens.

At block 13, the smart contract receives a second setting instruction from a transaction receiver, wherein the second setting instruction is used to set the second exchange rate at which the second tokens is exchanged for the first tokens.

In one embodiment, the transaction receiver is connected to one blockchain node on the blockchain. In one embodiment, the second setting instruction sent by the transaction sender is received by the smart contract on the blockchain node corresponding to the transaction receiver. In one embodiment, the transaction receiver is a different terminal device or is an account address other than that of the transaction sender.

At block 14, the smart contract receives a quantity of second transactions sent by the transaction receiver, and the second transactions are used to redeem the second tokens.

At block 15, the smart contract generates target transactions according to the first exchange rate, the quantity of the first transactions, the second exchange rate, and the quantity of the second transactions, and sends the transactions to a third-party platform to notify the third-party platform to mediate in relation to the target transactions.

In one embodiment, the target transactions include the first exchange rate, the quantity of the first transactions, and the second exchange rate and the quantity of the second transactions. In one embodiment, the third-part platform connects to one blockchain node. In one embodiment, the smart contract on the blockchain node corresponding to the third-party platform sends the target transactions to the third-party platform to notify the third-party platform to mediate in relation to the target transactions. In one embodiment, the third-party platform determines whether the target transactions match matchmaking conditions, the target transactions being established when the target transactions are found to match the matchmaking conditions. In one embodiment, the third-party platform determines whether the first tokens in an account of the transaction sender meets the quantity of the second transactions, and determines whether the second tokens in an account of the transaction receiver meets the quantity of the first transactions. The third-party platform also determines whether the first exchange rate is within a first threshold range, and determines whether the second exchange rate is within a second threshold range. The target transactions are established when the first tokens in the account of the transaction sender are found to meet the quantity of the second transactions, and when the second tokens in the account of the transaction receiver are found to meet the quantity of the first transactions. When the first exchange rate is within the first threshold range, and when the second exchange rate is within the second threshold range, a redemption instruction is sent to the smart contract when the target transactions are established. In one embodiment, the third-party platform is used to record the target transactions.

At block 16, the smart contract receives a redemption instruction sent by the third-party platform.

At block 17, in response to the redemption instruction, the smart contract sends the second tokens corresponding to the quantity of the first transactions to the transaction sender according to the quantity of the first transactions and the first exchange rate, and sends the first tokens corresponding to the quantity of the second transactions to the transaction receiver according to the quantity of the second transactions and the second exchange rate.

In one embodiment, in response to the redemption instruction, the smart contract determines whether the first tokens in an account of the transaction sender in fact meet the quantity of the second transactions, and determines whether the second tokens in an account of the transaction receiver in fact meet the quantity of the first transactions, and determines whether the first exchange rate is within the first threshold range. The smart contract also determines whether the second exchange rate is within the second threshold range. When the first tokens in the account of the transaction sender do meet the quantity of the second transactions, and when the second tokens in the account of the transacting receiver do meet the quantity of the first transactions, and when the first and second exchange rates are respectively within the first and second threshold ranges, the smart contract sends the second tokens corresponding to the quantity of the first transactions to the transaction sender according to the quantity of the first transactions and the first exchange rate, and sends the first tokens corresponding to the quantity of the second transactions to the transaction receiver according to the quantity of the second transactions and the second exchange rate.

In one embodiment, the method further includes: calculating an exchange rate difference between the first exchange rate and the second exchange rate, calculating target second tokens according to the exchange rate difference and the quantity of the first transaction, or calculating target first tokens according to the exchange rate difference and the quantity of the second transaction, and sending the target first tokens or the target second tokens to the third-party platform.

In one embodiment, the method further includes the smart contract receiving a transaction order establishment instruction sent by the transaction sender, establishing a transaction order which the first tokens are exchanged for the second tokens according to the transaction order establishment instruction.

In one embodiment, the method further includes: the smart contract receiving a redemption termination instruction sent by the transaction sender, returning the rest of the first tokens to the transaction sender and returning the rest of the second tokens to the transaction receiver according to the redemption termination instruction.

In present disclosure, the smart contract sends the second tokens corresponding to the quantity of the first transactions to the transaction sender according to the quantity of the first transactions and the first exchange rate, and sends the first tokens corresponding to the quantity of the second transactions to the transaction receiver according to the quantity of the second transactions and the second exchange rate. Thereby, a strict and correct execution of redemption is achieved, eliminating errors of manual operation. Moreover, any individual or organization willing to provide redemption services can deploy redemption contracts and operate redemption services on the blockchain as long as they have sufficient funds, and can do so without a complex exchange process, more service nodes on the blockchain ensure reliability and reasonable price of the redemption service.

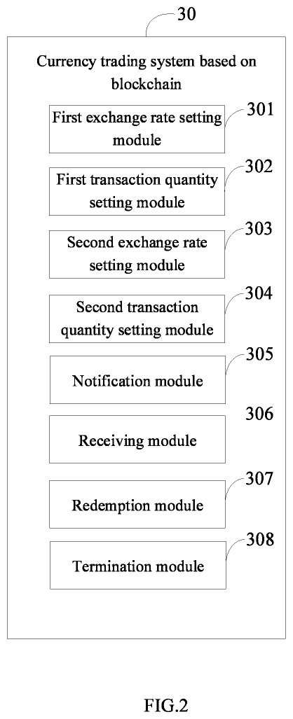

FIG. 2 illustrates a currency trading system 30 based on blockchain. The currency trading system 30 is applied in an electronic device 6. In one embodiment, according to the functions it performs, the currency trading system 30 can be divided into a plurality of functional modules. The functional modules perform the blocks 11-17 in the embodiment of FIG. 1 to perform the functions of currency trading.

The currency trading system 30 includes, but is not limited to, a first exchange rate setting module 301, a first transaction quantity setting module 302, a second exchange rate setting module 303, a second transaction quantity setting module 304, a notification module 305, a receiving module 306, a redemption module 307, and a termination module 308. The modules 301-308 of the trading system 30 can be collections of software instructions. The modules in the present disclosure refers to a series of computer program segments which can be executed by at least one processor and can perform the functions of currency trading based on the blockchain, the modules being stored in memory.

The first exchange rate setting module 301 makes a smart contract on the blockchain receive a first setting instruction from a transaction sender, the first setting instruction being used to set a first exchange rate at which a first token is exchanged for a second token.

In one embodiment, the blockchain includes multiple blockchain nodes, each blockchain node includes the smart contract. The transaction sender is connected to one blockchain node on the blockchain. In one embodiment, the smart contract on the blockchain receives the first setting instruction sent by the smart contract on the blockchain node corresponding to the transaction sender. In one embodiment, the transaction sender is a terminal device, for example, the terminal device may be a laptop, a smartphone, a tablet, or other device, or the transaction sender can be an account address.

The first transaction quantity setting module 302 makes the smart contract receive a quantity of first transactions sent by the transaction sender, and the first transactions are used to redeem the first tokens.

The second exchange rate setting module 303 makes the smart contract receive a second setting instruction from a transaction receiver, and the second setting instruction is used to set the second exchange rate at which the second tokens are exchanged for the first tokens.

In one embodiment, the transaction receiver is connected to one blockchain node on the blockchain. In one embodiment, the second setting instruction sent by the transaction sender is received by the smart contract on the blockchain node corresponding to the transaction receiver. In one embodiment, the transaction receiver is a different terminal device or account address other than that of the transaction sender.

The second transaction quantity setting module 304 makes the smart contract receive a quantity of second transactions sent by the transaction receiver, and the second transactions are used to redeem the second tokens.

The notification module 305 makes the smart contract generate target transactions according to the first exchange rate, the quantity of the first transactions, the second exchange rate and the quantity of the second transactions, and the transactions are sent to a third-party platform for the third-party platform to mediate the target transactions.

In one embodiment, the target transactions include the first exchange rate, the quantity of the first transactions, the second exchange rate and the quantity of the second transactions. In one embodiment, the third-part platform connects to one blockchain node. In one embodiment, the smart contract on the blockchain node corresponding to the third-party platform sends the target transactions to the third-party platform to notify the third-party platform to mediate the target transactions. In one embodiment, the third-party platform determines whether the target transactions match matchmaking conditions, the target transactions are established when the target transactions do match the matchmaking conditions. In one embodiment, the third-party platform determines whether the first tokens in an account of the transaction sender meets the quantity of the second transactions, and determines whether the second tokens in an account of the transaction receiver meets the quantity of the first transactions, and determines whether the first exchange rate is within a first threshold range, and determines whether the second exchange rate is within a second threshold range. The target transactions are established when the first tokens in the account of the transaction sender meets the quantity of the second transactions, and when the second tokens in the account of the transaction receiver meets the quantity of the first transactions, and when the first exchange rate is within the first threshold range, and when the second exchange rate is within the second threshold range, and sends a redemption instruction to the smart contract when the target transactions are established. In one embodiment, the third-party platform is used to record the target transactions.

The receiving module 306 makes the smart contract receive a redemption instruction sent by the third-party platform.

In response to the redemption instruction, the redemption module 307 makes the smart contract send the second tokens corresponding to the quantity of the first transactions to the transaction sender according to the quantity of the first transactions and the first exchange rate, and send the first tokens corresponding to the quantity of the second transactions to the transaction receiver according to the quantity of the second transactions and the second exchange rate.

In one embodiment, in response to the redemption instruction, the smart contract determines whether the first tokens in an account of the transaction sender meet the quantity of the second transactions, and determines whether the second tokens in an account of the transaction receiver meet the quantity of the first transactions, and determines whether the first exchange rate is within the first threshold range, and determines whether the second exchange rate is within the second threshold range. When the first tokens in the account of the transaction sender meets the quantity of the second transactions, and when the second tokens in the account of the transaction receiver meet the quantity of the first transactions, and when the first exchange rate is within the first threshold range, and when the second exchange rate is within the second threshold range, the smart contract sends the second tokens corresponding to the quantity of the first transactions to the transaction sender according to the quantity of the first transactions and the first exchange rate, and sends the first tokens corresponding to the quantity of the second transactions to the transaction receiver according to the quantity of the second transactions and the second exchange rate.

In one embodiment, the redemption module 307 makes the smart contract calculate an exchange rate difference between the first exchange rate and the second exchange rate, calculate a number of target second tokens according to the exchange rate difference and the quantity of the first transactions, or calculate a target number of first tokens according to the exchange rate difference and the quantity of the second transactions, and send the target first tokens or the target second tokens to the third-party platform.

In one embodiment, the redemption module 307 makes the smart contract receive a transaction order establishment instruction sent by the transacting sender, and establish a transaction order which the first tokens are exchanged for the second tokens according to the transaction order establishment instruction.

In one embodiment, the termination module 308 makes the smart contract receive a redemption termination instruction sent by the transacting sender, and return the rest of the first tokens to the transacting sender and return the rest of the second tokens to the transacting receiver according to the redemption termination instruction.

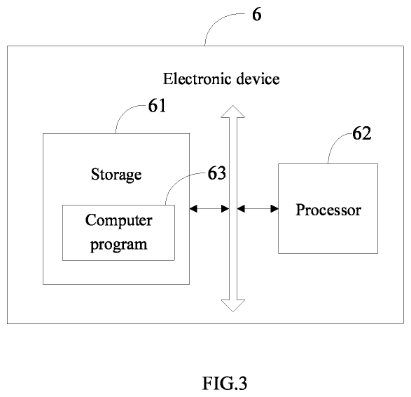

FIG. 3 illustrates an electronic device (electronic device 6). The electronic device 6 includes a storage 61, a processor 62, and a computer program 63 stored in the storage 61 and executed by the processor 62. When the processor 62 executes the computer program 63, the blocks in the embodiment of the currency trading method based on blockchain are implemented, for example, blocks 11 to 17 as shown in FIG. 1. Alternatively, when the processor 62 executes the computer program 63, the functions of the modules in the embodiment of the currency trading system 30 based on blockchain are implemented, for example, modules 301-308 shown in FIG. 2.

In one embodiment, the computer program 63 can be partitioned into one or more modules/units that are stored in the storage 61 and executed by the processor 62. The one or more modules/units may be a series of computer program instruction segments capable of performing a particular function, and the instruction segments describe the execution of the computer program 63 in the electronic device 6. For example, the computer program 63 can be divided into the first exchange rate setting module 301, the first transaction quantity setting module 302, the second exchange rate setting module 303, the second transaction quantity setting module 304, the notification module 305, the receiving module 306, the redemption module 307, and the termination module 308 as shown in FIG. 2.

In one embodiment, the electronic device 6 is a server, a terminal device, or a cloud server. FIG. 3 shows only one example of the electronic device 6, other examples may include more or less components than those illustrated, or some components may be combined, or have a different arrangement. The components, such as the electronic device 6, may also include input devices, output devices, communication unit, network access devices, buses, and the like.

The processor 62 can be a central processing unit (CPU), and also include other general-purpose processors, a digital signal processor (DSP), and application specific integrated circuit (ASIC), Field-Programmable Gate Array (FPGA) or other programmable logic device, discrete gate or transistor logic device, and discrete hardware components, etc. The processor 62 may be a microprocessor or the processor may be any conventional processor or the like. The processor 62 is the control center of the electronic device 6, and connects to the entire electronic device 6 by using various interfaces and lines.

The storage 61 stores data and programs of the electronic device 6. For example, the storage 61 can store the trading system 30 based on blockchain. In at least one exemplary embodiment, the storage 61 can include various types of non-transitory computer-readable storage mediums. For example, the storage 61 can be an internal storage system, such as a flash memory, a random access memory for temporary storage of information, and/or a read-only memory for permanent storage of information. The storage 61 can also be an external storage system, such as a hard disk, a storage card, or a data storage medium.

In one embodiment, the modules/units integrated in the electronic device 6 can be stored in a computer readable storage medium if such modules/units are in the form of a purchased product. Thus, the present disclosure may be implemented and realized in any part of the method of the foregoing embodiments, or may be implemented by the computer program, which may be stored in the computer readable storage medium. The steps of the various method embodiments described above may be implemented by a computer program when executed by a processor. The computer program includes computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM), electrical carrier signals, telecommunication signals, and software distribution media.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. An electronic device comprising:
a processor;
a non-transitory storage medium coupled to the processor and configured to store a plurality of instructions, which causes the processor to:
make a smart contract on a blockchain receive a first setting instruction from a transaction sender, and the first setting instruction setting a first exchange rate at which a first token is exchanged for a second token;
make the smart contract receive a quantity of first transactions sent by the transaction sender, and the first transactions redeeming first tokens;
make the smart contract receive a second setting instruction from a transaction receiver, and the second setting instruction setting the second exchange rate at which the second tokens is exchanged for the first tokens;
make the smart contract receive a quantity of second transactions sent by the transaction receiver, and the second transactions redeeming the second tokens;
make the smart contract generate target transactions according to the first exchange rate, the quantity of the first transactions, the second exchange rate and the quantity of the second transactions, and send the target transactions to a third-party platform to notify the third-party platform to mediate the target transactions; and
make the smart contract receive a redemption instruction sent by the third-party platform, wherein
in response to the redemption instruction, make the smart contract send the second tokens corresponding to the quantity of the first transactions to the transaction sender according to the quantity of the first transactions and the first exchange rate, and send the first tokens corresponding to the quantity of the second transactions to the transaction receiver according to the quantity of the second transactions and the second exchange rate.

2. The electronic device according to claim 1, wherein the plurality of instructions is further configured to cause the processor to:
make the third-party platform determine whether the target transactions match matchmaking conditions, and the target transactions are established when the target transactions matches the matchmaking conditions.

3. The electronic device according to claim 2, wherein the plurality of instructions is further configured to cause the processor to:
make the third-party platform determine whether the first tokens in an account of the transaction sender meet the quantity of the second transactions, and determine whether the second tokens in an account of the transaction receiver meet the quantity of the first transactions, and determine whether the first exchange rate is within a first threshold range, and determine whether the second exchange rate is within a second threshold range;
establish the target transactions when the first tokens in the account of the transaction sender meet the quantity of the second transactions, and when the second token in the account of the transaction receiver meet the quantity of the first transactions, and when the first exchange rate is within the first threshold range, and when the second exchange rate is within the second threshold range; and
send a redemption instruction to the smart contract when the target transactions are established.

4. The electronic device according to claim 1, wherein the plurality of instructions is further configured to cause the processor to:
make the smart contract determine whether the first tokens in an account of the transaction sender meets the quantity of the second transactions, and determines whether the second tokens in an account of the transaction receiver meets the quantity of the first transactions;
determine whether the first exchange rate is within the first threshold range, and determine whether the second exchange rate is within the second threshold range;
when the first tokens in the account of the transaction sender meeting the quantity of the second transactions, and when the second tokens in the account of the transaction receiver meeting the quantity of the first transactions, and when the first exchange rate being within the first threshold range, and when the second exchange rate being within the second threshold range, send the second tokens corresponding to the quantity of the first transactions to the transaction sender according to the quantity of the first transactions and the first exchange rate, and send the first tokens corresponding to the quantity of the second transactions to the transaction receiver according to the quantity of the second transactions and the second exchange rate.

5. The electronic device according to claim 1, wherein the plurality of instructions is further configured to cause the processor to:
make the smart contract calculate an exchange rate difference between the first exchange rate and the second exchange rate;
calculate target second tokens according to the exchange rate difference and the quantity of the first transactions, or calculate target first tokens according to the exchange rate difference and the quantity of the second transactions;
and send the target first tokens or the target second tokens to the third-party platform.

6. The electronic device according to claim 1, wherein the plurality of instructions is further configured to cause the processor to:
make the smart contract receive a transaction order establishment instruction sent by the transaction sender, establish a transaction order which the first tokens are exchanged for the second tokens according to the transaction order establishment instruction.

7. The electronic device according to claim 1, wherein the plurality of instructions is further configured to cause the processor to:
make the smart contract receive a redemption termination instruction sent by the transaction sender;
return the rest of the first tokens to the transaction sender and return the rest of the second tokens to the transaction receiver according to the redemption termination instruction.

8. A currency trading method based on blockchain comprising:
making a smart contract on a blockchain receive a first setting instruction from a transaction sender, and the first setting instruction setting a first exchange rate at which a first token is exchanged for a second token;
making the smart contract receive a quantity of first transactions sent by the transaction sender, and the first transactions redeeming first tokens;
making the smart contract receive a second setting instruction from a transaction receiver, and the second setting instruction setting the second exchange rate at which the second tokens is exchanged for the first tokens;
making the smart contract receive a quantity of second transactions sent by the transaction receiver, and the second transactions redeeming the second tokens;
making the smart contract generate target transactions according to the first exchange rate, the quantity of the first transactions, the second exchange rate and the quantity of the second transactions, and send the target transactions to a third-party platform to notify the third-party platform to mediate the target transactions; and
making the smart contract receive a redemption instruction sent by the third-party platform, wherein
in response to the redemption instruction, making the smart contract send the second tokens corresponding to the quantity of the first transactions to the transaction sender according to the quantity of the first transactions and the first exchange rate, and send the first tokens corresponding to the quantity of the second transactions to the transaction receiver according to the quantity of the second transactions and the second exchange rate.

9. The currency trading method based on blockchain according to claim 8, further comprising:
making the third-party platform determine whether the target transactions match matchmaking conditions, and the target transactions being established when the target transactions matches the matchmaking conditions.

10. The currency trading method based on blockchain according to claim 9, further comprising:
making the third-party platform determine whether the first tokens in an account of the transaction sender meet the quantity of the second transactions, and determine whether the second tokens in an account of the transaction receiver meet the quantity of the first transactions, and determine whether the first exchange rate is within a first threshold range, and determine whether the second exchange rate is within a second threshold range;
establish the target transactions when the first tokens in the account of the transaction sender meet the quantity of the second transactions, and when the second token in the account of the transaction receiver meet the quantity of the first transactions, and when the first exchange rate is within the first threshold range, and when the second exchange rate is within the second threshold range; and
send a redemption instruction to the smart contract when the target transactions are established.

11. The currency trading method based on blockchain according to claim 8, further comprising:
making the smart contract determine whether the first tokens in an account of the transaction sender meets the quantity of the second transactions, and determines whether the second tokens in an account of the transaction receiver meets the quantity of the first transactions;
determine whether the first exchange rate is within the first threshold range, and determine whether the second exchange rate is within the second threshold range;
when the first tokens in the account of the transaction sender meeting the quantity of the second transactions, and when the second tokens in the account of the transaction receiver meeting the quantity of the first transactions, and when the first exchange rate being within the first threshold range, and when the second exchange rate being within the second threshold range, send the second tokens corresponding to the quantity of the first transactions to the transaction sender according to the quantity of the first transactions and the first exchange rate, and send the first tokens corresponding to the quantity of the second transactions to the transaction receiver according to the quantity of the second transactions and the second exchange rate.

12. The currency trading method based on blockchain according to claim 8, further comprising:
making the smart contract calculate an exchange rate difference between the first exchange rate and the second exchange rate;
calculate target second tokens according to the exchange rate difference and the quantity of the first transactions, or calculate a target first tokens according to the exchange rate difference and the quantity of the second transactions;
and send the target first tokens or the target second tokens to the third-party platform.

13. The currency trading method based on blockchain according to claim 8, further comprising:
making the smart contract receive a transaction order establishment instruction sent by the transaction sender, establish a transaction order which the first tokens are exchanged for the second tokens according to the transaction order establishment instruction.

14. The currency trading method based on blockchain according to claim 8, further comprising:
making the smart contract receive a redemption termination instruction sent by the transaction sender;
return the rest of the first tokens to the transaction sender and return the rest of the second tokens to the transaction receiver according to the redemption termination instruction.

15. A non-transitory storage medium having stored thereon instructions that, when executed by at least one processor of an electronic device, causes the least one processor to execute instructions of a currency trading method based on blockchain, the method comprising:
making a smart contract on a blockchain receive a first setting instruction from a transaction sender, and the first setting instruction setting a first exchange rate at which a first token is exchanged for a second token;
making the smart contract receive a quantity of first transactions sent by the transaction sender, and the first transactions redeeming first tokens;
making the smart contract receive a second setting instruction from a transaction receiver, and the second setting instruction setting the second exchange rate at which the second tokens is exchanged for the first tokens;
making the smart contract receive a quantity of second transactions sent by the transaction receiver, and the second transactions redeeming the second tokens;
making the smart contract generate target transactions according to the first exchange rate, the quantity of the first transactions, the second exchange rate and the quantity of the second transactions, and send the target transactions to a third-party platform to notify the third-party platform to mediate the target transactions; and
making the smart contract receive a redemption instruction sent by the third-party platform, wherein
in response to the redemption instruction, making the smart contract send the second tokens corresponding to the quantity of the first transactions to the transaction sender according to the quantity of the first transactions and the first exchange rate, and send the first tokens corresponding to the quantity of the second transactions to the transaction receiver according to the quantity of the second transactions and the second exchange rate.

16. The non-transitory storage medium according to claim 15, wherein the method further comprising:
making the third-party platform determine whether the target transactions match matchmaking conditions, and the target transactions being established when the target transactions matches the matchmaking conditions.

17. The non-transitory storage medium according to claim 16, wherein the method further comprising:
making the third-party platform determine whether the first tokens in an account of the transaction sender meet the quantity of the second transactions, and determine whether the second tokens in an account of the transaction receiver meet the quantity of the first transactions, and determine whether the first exchange rate is within a first threshold range, and determine whether the second exchange rate is within a second threshold range;
establish the target transactions when the first tokens in the account of the transaction sender meet the quantity of the second transactions, and when the second token in the account of the transaction receiver meet the quantity of the first transactions, and when the first exchange rate is within the first threshold range, and when the second exchange rate is within the second threshold range; and
send a redemption instruction to the smart contract when the target transactions are established.

18. The non-transitory storage medium according to claim 15, wherein the method further comprising:
making the smart contract determine whether the first tokens in an account of the transaction sender meets the quantity of the second transactions, and determines whether the second tokens in an account of the transaction receiver meets the quantity of the first transactions;
determine whether the first exchange rate is within the first threshold range, and determine whether the second exchange rate is within the second threshold range;
when the first tokens in the account of the transaction sender meeting the quantity of the second transactions, and when the second tokens in the account of the transaction receiver meeting the quantity of the first transactions, and when the first exchange rate being within the first threshold range, and when the second exchange rate being within the second threshold range, send the second tokens corresponding to the quantity of the first transactions to the transaction sender according to the quantity of the first transactions and the first exchange rate, and send the first tokens corresponding to the quantity of the second transactions to the transaction receiver according to the quantity of the second transactions and the second exchange rate.

19. The non-transitory storage medium according to claim 15, wherein the method further comprising:
making the smart contract calculate an exchange rate difference between the first exchange rate and the second exchange rate;
calculate target second tokens according to the exchange rate difference and the quantity of the first transactions, or calculate target first tokens according to the exchange rate difference and the quantity of the second transactions;
and send the target first tokens or the target second tokens to the third-party platform.

20. The non-transitory storage medium according to claim 15, wherein the method further comprising:
making the smart contract receive a transaction order establishment instruction sent by the transaction sender, establish a transaction order which the first tokens are exchanged for the second tokens according to the transaction order establishment instruction.
